(19) United States
(12) Patent Application Publication
(10) Pub. No.: US 2009/0156426 A1
(43) Pub. Date: Jun. 18, 2009

(54) FUNCTIONALIZED POROUS SUPPORTS FOR MICROARRAYS

(76) Inventors: Thomas Schiestel, Stuttgart (DE); Steffen Rupp, Stuttgart (DE)

Correspondence Address: OSTROLENK FABER GERB & SOFFEN, 1180 AVENUE OF THE AMERICAS, NEW YORK, NY, 100368403, US

(21) Appl. No.: 11/568,162

(22) PCT Filed: Apr. 9, 2005
(86) PCT No.: PCT/EP2005/003744

§ 371 Date: Dec. 12, 2006

(30) Foreign Application Priority Data
Apr. 23, 2004 (DE) 10 2004 021 351.8

(51) Int. Cl. C40B 30/08; C40B 40/00; C40B 40/08; C40B 40/10; C40B 50/18; C40B 30/00; C40B 30/10

(52) U.S. Cl. 506/11; 506/13; 506/17; 506/18; 506/32; 506/7; 506/12

(57) ABSTRACT

The present invention relates to functionalized porous carriers which comprise a material having at least one porous surface, nanoparticles having molecule-specific recognition sites being present in the pores of the material surface, and to a process for producing functionalized porous carriers. The invention further relates to functional elements produced using the functionalized carriers, such as microtiter plates, microarrays and flow devices, and also to uses of the functionalized carriers and functional elements.

The present invention relates to functionalized porous carriers which comprise a material having at least one porous surface, nanoparticles having molecule-specific recognition sites being present in the pores of the material surface, and to a process for producing functionalized porous carriers. The invention further relates to functional elements produced using the functionalized carriers, such as microtiter plates, microarrays and flow devices, and to uses of the functionalized carriers and functional elements.

In the last few years, highly parallel miniaturized processes on solid phases for the synthesis of active medical ingredients and for the analysis of nucleic acids and proteins have increasingly been developed. This trend toward ever greater miniaturization is being forced in particular by combinatorial chemistry and high-throughput screening (HTS). The two sectors today are two of the most important pillars of the modern search for active pharmaceutical ingredients. HTS is, for example, a means of investigating whether an active ingredient which can be used as a basis for new medicaments is present in a substance library. The components of the substance library are examined with regard to their reactivity with a target (target molecule) in a test process. The substances found are possible candidates for an active ingredient which can influence the function of the target molecule in question. The active ingredients are detected either by means of optical processes such as absorption, fluorescence, luminescence, or by means of the detection of radioactivity via scintillation. The multitude of interactions to be investigated causes great variance in the test systems and the detection types associated with them.

The search for active ingredients requires first that the targets which are responsible for the development of diseases have to be found. As a result of growing understanding of modern molecular biology, it has thus been possible in recent times to identify ever more disease-causing and disease-influencing genes, on which it is then possible to act with suitable medicaments. A milestone in the analysis of biologically active molecules, especially for the identification of the genes responsible for the development of diseases, is that of miniaturized carrier systems known as biochips or microarrays. Such microarrays or biochips are characterized in that a multitude of biologically active molecules are preferably immobilized or synthesized in an ordered pattern on their surface. The immobilized biological molecules may, for example, be nucleic acids, oligonucleotides, proteins or peptides. Biochips or microarrays are used, inter alia, in the clinical diagnostics of infections, cancer and hereditary disorders. With the aid of such biochips or microarrays, nucleic acid or protein determination in samples to be analyzed can be significantly simplified, accelerated, parallelized, automated and made more precise. The use of microarrays makes it possible, for example, to analyze thousands of genes or proteins simultaneously in one experiment. The efficiency of biochips or microarrays in the analysis of samples is based in particular on the fact that only small sample volumes are required and the evaluation can be effected by means of high-sensitivity test methods.

Owing to the ever greater miniaturization of the microarrays, the test systems to be performed using these arrays are also being miniaturized ever more greatly. As a result of this, increased demands are also being placed on the detection devices with increasingly smaller volumes. For instance, it is known that specific problems occur in extremely small volumes in the individual detection types. For example, in luminescence measurement, a relatively small sample volume also means a relatively small signal for the optical detection, which greatly impairs the sensitivity of the measurement. The absorption measurement in microarrays is disrupted in particular by the meniscus effect of the liquid surface, since the meniscus has a very variable profile in extremely small sample chambers. Although fluorescence measurement in microarrays is not subject to any volume restriction, the achievable sensitivity here is restricted by the intrinsic fluorescence of the plastics materials frequently used as microarray carriers, which is also detected by most processes.

Conventional microarrays are usually produced using planar solid-state surfaces such as glass, metals or plastics (Ramsey, Nature Biotechn., 16 (1998), 40-44). However, it has been found that the materials used currently for microarray production have a series of deficiencies, especially with regard to the sensitivity, the quality and hence the reproducibility of the results obtained using conventional planar solid-state surfaces and the storability (Collins, Sonderheft, Nat. Genetics, (1999) 21). For example, it is barely possible using conventional solid-state surfaces to apply the molecules to be immobilized on the surface such that the molecules are distributed uniformly within the spot obtained. For the size of the spots on the surface, what is of crucial importance is in particular the surface tension of the solution droplet which comprises the molecules and has been applied to the surface. When the solution has, for example, low surface tension, only spots having a diameter in the micrometer range are obtained in the case of hydrophilic surfaces, even when small volumes are applied, and the molecules collect at the outer edge in particular during the drying of the solution droplets. Since the molecules deposited are frequently present at the edge of the spot but not in the center thereof, this leads later to sensitivity problems. For this reason, the surface, especially in the case of glass, is frequently silanized. However, in this case too, individual solution droplets frequently coalesce on the surface, so that reproducibility of the results obtained using such microarrays is not ensured.

In the prior art, approaches are also known to increase the sensitivity of microchips by the use of nonplanar surfaces. For example, polymer gel-modified microscope slides have been described as three-dimensional DNA microarrays (Zlatanova and Mirzabekov, Methods Mol. Biol., 170 (2001), 17-38). The gel provides a three-dimensional aqueous environment which, owing to the surface enlargement achieved, brings advantages especially for enzymatic reactions. Further processes for surface enlargement include the use of complex polymer structures such as dendrimers. However, the use of such polymer structures is very expensive. In addition, so-called flow-through chips are known, which comprise microchannels in porous substrates for depositing DNA. Similar systems based on hollow fibers are known, for example, from WO 02/05945 and DE 100 15 391 A1.

The use of membranes as a carrier of biochips has also been described, for example in WO 01/61042 and in WO 03/049851. However, membranes are afflicted with some disadvantages. For example, it is not possible when using membranes to produce microarrays having a spot separation of less than 200 μm. Porous membranes have the properties of sucking in liquids, so that narrow areal delimitation of the individual spots is not possible.

In the pharmaceutical research industry and in fundamental research, the above problems can be tolerated only when a qualitative statement is to be obtained, i.e. when only the difference in the signal intensity between individual spots is to be detected in the screening of many samples in parallel batches. However, the situation is completely different in clinical diagnostics. Here, for example, samples of a patient very frequently have to be subjected to a multitude of different test methods using different reactants, each test comprising relatively few parallel batches. It is likewise frequently necessary to test very many samples of different patients for a single parameter. In contrast to high-throughput screening, the individual clinical tests frequently have to enable very definitive quantitative statements, in order, for example, to be able to detect the onset or course of a disorder in individual patients. The problems connected with conventional solid-state surfaces can therefore lead to serious errors in the measurements obtained in clinical diagnostics. The accuracy of the results obtained therefore plays a considerably greater role in clinical diagnostics than, for example, in the high-throughput screening of active ingredients.

The technical problem underlying the present invention is therefore that of providing carrier materials, especially for microarray systems, and processes for their production, with which the disadvantages of the materials typically used to produce the microarrays can be overcome, and the materials should in particular provide a considerably enlarged active surface compared to conventional systems per spot for the performance of chemical reactions, but without reducing the density of the spots on the microchips, and which, as a result, enable an increase in the sensitivity of detection processes with an improved signal-to-noise ratio.

The present invention solves the underlying technical problem by the provision of a functionalized porous carrier comprising a material having a surface arranged on the upper side of the material and a surface arranged on the lower side of the material, at least one surface being planar and having pores, and nanoparticles, especially nanoparticles having molecule-specific recognition sites, being arranged in the pores, preferably solely and exclusively in the pores, of at least one region of the porous surface.

The present invention thus provides a functionalized porous carrier having at least two opposite surfaces, nanoparticles being arranged solely or only within the pores of at least one surface, but not on this surface itself, the nanoparticles being provided in a preferred embodiment with molecule-specific recognition sites. When the nanoparticles present in the pores do not have molecule-specific recognition sites, they can be provided with them subsequently. The molecule-specific recognition sites of the nanoparticles can bind corresponding molecules, especially organic molecules having a biological function or activity, for example proteins or nucleic acids. Other molecules can then be bound to these molecules, for example molecules of a sample to be analyzed. Advantageously, the molecules immobilized on the nanoparticles, when suitable conditions are used, can be removed again from the nanoparticles. The molecules bound to immobilized molecules can also be removed again from the immobilized molecules under suitable conditions. In contrast to conventional planar surfaces, it is thus provided in the inventive carrier that the molecules to be immobilized on the surface of the carrier are not immobilized directly on the surface of the carrier but rather on nanoparticles with molecule-specific recognition sites. The invention provides for the arrangement of the nanoparticles not on the carrier surface but rather solely in the pores, i.e. within the pores of the carrier surface.

The invention thus provides a carrier which is functionalized by the presence of the nanoparticles and is thus addressable. The nanoparticles used in accordance with the invention have a diameter of 5 nm to 1000 nm, and a comparatively very large surface-to-volume ratio. The very large nanoparticle surface area allows a multitude of molecule-specific recognition sites to be arranged thereon, so that a large amount of a biological molecule can accordingly be bound per unit mass. Depending on the size of the pores, a multitude of nanoparticles may be present in an individual pore of the inventive carrier, so that the invention provides a very large active surface area for the binding of analytes per unit carrier surface area per pore. The inventive functionalized carrier thus has the advantage of a very large active surface area, which results from the number of pores per unit carrier surface area, the size of the pores and the available surface area of the nanoparticles.

In comparison to conventional microarray systems, in which molecules are bonded directly on a planar carrier, the active surface provided in accordance with the invention for analyte binding per unit carrier surface area is considerably enlarged. Caused by the active surface area drastically enlarged in accordance with the invention, it is thus also possible in accordance with the invention to bind a considerably greater amount of analyte efficiently per unit carrier surface area, the analyte simultaneously also being distributed very uniformly within one surface area unit. The amount of analyte bound per unit carrier surface area, i.e. the packing density, can be increased even further in accordance with the invention by using, for example, porous carrier materials which have continuous pores, so that more nanoparticles can be arranged within the pores than in carriers with pores which do not pass through the carrier material. In comparison to conventional microarray carrier surfaces, the inventive functionalized porous carrier therefore advantageously allows greater enrichment of the analyte with very uniform distribution. In contrast to the microarray carrier surfaces known in the prior art, the active surface area enlarged in accordance with the invention is, however, not arranged on the carrier surface, but rather in the interior of the porous carrier, specifically in its pores.

The drastic enlargement of the active surface area achieved in the interior of the carrier in accordance with the invention offers a series of further advantages over conventional materials. A significant advantage of the inventive functionalized carrier is, for example, that, using the inventive functionalized carrier, an extremely high spot density, as required in microarrays, can be achieved. The invention provides, for example, that the customary pattern structure of microarrays consisting of individual spots is achieved on the inventive functionalized carrier by controlled disruption of the pore structure of the porous surface in predefined regions, i.e. in accordance with a predefined pattern, before the nanoparticles are introduced into the pores. The spots which are obtained by the introduction of the nanoparticles into the remaining pores can be delimited from one another very efficiently, the distances between the individual spots being significantly less than 200 μm, preferably at most a few micrometers. When nanoparticles having a core diameter of a few nanometers are used, the separation of the individual spots, owing to the drastically increased active surface area in the interior of the inventive functionalized carrier, may even be in the nanometer range. Using the inventive functionalized carrier, it is thus also possible to achieve an extremely high spot density which significantly exceeds the spot density achieved in the case of conventional microarray carrier materials.

A further advantage is that, in the inventive functionalized carrier, the individual spots, unlike conventional microarray carrier materials, cannot interact with one another. This is caused firstly by the analyte not being bound on the carrier itself but rather on nanoparticles, and secondly by the nanoparticles arranged within different pores being separated from one another spatially by the pore wall or pore walls, so that interaction between individual spots is prevented.

Owing to the considerably enlarged active surface area and the associated much greater analyte enrichment, without there being interactions between individual spots, the sensitivity of the detection methods typically used is also increased considerably when the inventive functionalized carriers are used, which in particular also significantly improves the signal-to-noise ratio. Samples can be detected, for example, via fluorescence- or enzyme-labeled antibodies or DNA probes, or else without labeling via MALDI-MS processes, for which it is also possible in an advantageous manner to use conventional read-out devices. Using the inventive functionalized carriers, it is thus possible to obtain very definitive, reproducible results.

A particular advantage of the inventive functionalized carriers is also that the pores of porous materials are stable carriers for nanoparticles, since the nanoparticles adhere very efficiently in the pores or on the pore walls. In addition, the nanoparticles arranged within the pores may also be crosslinked covalently to one another and/or to the pore walls. For example, ceramic particles may be bonded by sintering to the pores of ceramic membranes. In the case of prolonged storage of the inventive functionalized carrier, the pores additionally, as moist chambers, offer optimal conditions for nanoparticles, especially nanoparticles provided with molecule-specific recognition sites. Moist chambers are important in particular for proteins immobilized on nanoparticles. A further advantage of the inventive functionalized carrier is that, owing to its porous structure, outstanding convection is achieved, which leads to a considerable rise in conversion.

The inventive functionalized porous carrier additionally enables efficient ingress of analytes and reagents and likewise efficient egress of waste products. The ingress of analytes and reagents can, in accordance with the invention, be improved further by applying, on the surface of the porous carrier, one or more additional separating layers which prevent the ingress of relatively large undesired particles, for example matrix particles. In this way, it is possible, for example, to prevent such undesired relatively large particles from getting into the pores and blocking them.

The nanoparticles used in the inventive functionalized carriers can be provided with very different molecule-specific recognition sites and therefore offer the possibility of immobilizing very different organic molecules for a wide variety of different purposes, the immobilized molecules also being removable again in an advantageous manner from the nanoparticles when suitable conditions are employed. Nanoparticles constitute extremely flexible and inert systems. They may consist, for example, of a wide variety of different cores, for example organic polymers or inorganic materials. At the same time, inorganic nanoparticles such as silicon particles offer the advantage that they are chemically extremely inert and mechanically stable. While surfmers and molecularly imprinted polymers have soft cores, nanoparticles with silica or iron cores exhibit no swelling in solvents. Nonswellable particles do not change their morphology even if they are suspended repeatedly in solvents over a prolonged period. Porous carriers functionalized in accordance with the invention, in whose pores nonswellable nanoparticles are present, can therefore be used without any problem in analysis, diagnosis or synthesis methods which entail the use of solvents, without the state of the nanoparticles or of the immobilized biological molecules being influenced disadvantageously. Inventive functionalized porous carriers which comprise such nanoparticles can therefore also be used to purify the biological molecules to be immobilized from complex substance mixtures which comprise undesired substances such as detergents or salts, in which case the molecules to be immobilized can be removed optimally from such substance mixtures throughout washing processes of any length. On the other hand, superparamagnetic or ferromagnetic nanoparticles having an iron oxide core can become aligned in a magnetic field along the field lines. This property of iron oxide nanoparticles can be utilized in order to form, for example, nanoscopic conductor tracks within the functionalized porous carrier.

The inventive functionalized porous carriers can be used to immobilize a wide variety of different organic, especially biological, active molecules, and, in the case of biologically active molecules, their biological activity can even be preserved. The nanoparticles used to form the inventive functionalized porous carriers can be provided with molecule-specific recognition sites, especially functional chemical groups, which can bind the molecule to be immobilized such that the molecule regions required for the biological activity can be present in a state corresponding to the native molecule state. Depending on the functional groups present on the nanoparticle surface, the organic molecules may, as required, be bonded covalently and/or noncovalently to the nanoparticles. The nanoparticles may have different functional groups, so that either different organic molecules or molecules with different functional groups can be immobilized with preferred alignment. The molecules can be immobilized on the nanoparticles either in an unaligned or aligned manner, virtually any desired alignment of the molecules being possible. The immobilization of the organic molecules onto the nanoparticles present in the carrier pores also achieves stabilization of the molecules. In an advantageous manner, the molecules immobilized on the nanoparticles can also be removed again from the nanoparticles.

The inventive functionalized porous carriers may therefore comprise, in their pores, very different nanoparticles, especially nanoparticles with different molecule-specific recognition sites. Accordingly, an inventive functionalized porous carrier can also be covered with a wide variety of different molecule functions, especially biological functions. An inventive functionalized porous carrier can thus comprise, in its pores, different nanoparticles which, owing to the different molecule-specific recognition sites which are applied or have been applied to the nanoparticle surface, may also comprise different organic molecules or be provided with them. An inventive functionalized porous carrier may therefore comprise, for example, a plurality of different proteins or a plurality of different nucleic acids, or simultaneously proteins and nucleic acids.

The inventive functionalized porous carriers can be produced in a simple manner using known processes. For example, it is possible in a very simple manner using suitable suspension media, from nanoparticles, to obtain stable suspensions which behave like solutions and can therefore be applied in a simple manner to porous support materials. In an advantageous manner, it is also possible to deposit different nanoparticle suspensions in a structured manner on suitable porous carrier materials, for which conventional spotter devices can be used.

According to the invention, the possibility also exists of anchoring the nanoparticles in the pores additionally with use of a bonding agent. When a suitable bonding agent is used, the possibility then exists, for example, of fixing nanoparticles in the pores such that they can be removed at a later time partly or fully from the pores of the inventive functionalized carrier, especially by changes in the pH or the temperature.

The inventive functionalized carriers can be used for a multitude of very different applications, especially in automatable reaction and washing steps. Using the inventive functionalized carrier, it is possible, for example, to produce devices such as gene arrays, protein arrays or microtiter plates which can be used in medical analysis or diagnostics. The inventive functionalized carriers or the functional elements produced therefrom can also be used as an electronic component, for example as a molecular circuit, in medical measurement and monitoring technology or in a biocomputer. The inventive functionalized porous carriers or functional elements produced therefrom may also be used to remove molecules from a liquid medium.

In the context of the present invention, a “functionalized porous carrier” is understood to mean a material which is preferably lamellar and preferably has two opposite surfaces, i.e. one surface on the lower side of the material and one surface on the upper side of the material. At least one of the two surfaces has a planar shape and has pores, nanoparticles having a size of about 5 nm to 1000 nm, preferably nanoparticles having molecule-specific recognition sites, being present at least in some of the pores, and the nanoparticles optionally being present in immobilized and/or fixed form within the pores. For example, the nanoparticles may be crosslinked to one another and/or to the pore walls. In some embodiments, the porous material may also have a geometric shape which has more than two surfaces.

The material having the at least one porous surface serves in particular as a means of attachment for the functionalized nanoparticles. The inventive functionalized carrier allows the detection of molecules of a sample. Using the functionalized carrier, it is possible to detect even relatively small amounts of a molecule in a very small sample when the molecule can bind to the molecule-specific recognition sites of the nanoparticles or molecules bound thereto under suitable conditions. A porous functionalized carrier can therefore be used, for example, to produce a biochip, by virtue of biologically active molecules fixed or immobilized on the nanoparticle surface being introduced into the pores of the carrier together with the nanoparticles.

In the context of the present invention, “functionalized carrier” means a carrier which has been provided with a function, especially an addressable function. Since nanoparticles are binder matrices, an inventive functionalized carrier which comprises nanoparticles has the function of a binder matrix, especially for molecule-specific recognition sites which can be applied to the nanoparticle surface, and organic molecules which can be immobilized on the nanoparticles by means of the molecule-specific recognition sites. In the context of the present invention, “addressable function” means that the nanoparticles arranged in the pores of the functionalized porous carrier can be found and/or detected again. When the nanoparticles are applied to the surface of the porous material in a structured manner, for example using a mask or a die, so that they can penetrate into the pores of the porous material, the address of the nanoparticles applied in a structured manner results from the coordinates x and y of the region of the carrier surface predefined by the mask or the die, onto which surface the nanoparticles have been applied and in which the pores comprise nanoparticles. When the nanoparticles have been labeled, for example, with detection labels such as fluorophores, spin labels, gold particles, radioactive labels, etc., the nanoparticles applied in a structured manner can be detected using correspondingly suitable detection methods.

In the case of nanoparticles with molecule-specific recognition sites, the address of the nanoparticles applied in a structured manner also results from the molecule-specific recognition sites on the surface of the nanoparticles, which allow refinding or detection of the nanoparticles applied in a structured manner. When the nanoparticles applied in a structured manner are particles with molecule-specific recognition sites, to which no organic molecules have been bonded, the structure of nanoparticles formed in certain porous regions of the carrier surface can be found and/or detected again by virtue of one or more organic molecules binding specifically to the molecule-specific recognition sites of the nanoparticles present in certain porous regions. However, the molecules are not bound specifically in the surface sections or zones of the surface of the functionalized carrier in which the pores do not comprise nanoparticles. If the immobilized organic molecule has been labeled, for example, with detection labels such as fluorophores, spin labels, gold particles, radioactive labels, etc., the nanoparticles applied in a structured manner can be detected using correspondingly suitable detection methods.

When the structure formed by the applied nanoparticles comprises nanoparticles on whose molecule-specific recognition sites one or more organic molecules have already been bound, “addressable” means that these biomolecules can be found and/or detected by interaction with complementary structures of further molecules and/or by means of analytical methods. In this case, only the regions in which the pores comprise nanoparticles show signals, but not the sections of the surface of the porous carrier in which the pores do not comprise nanoparticles. The detection method used may, for example, be matrix-assisted laser desorption ionization time-of-flight mass spectrometry (MALDI-TOF-MS), which has developed to become an important process for the analysis of different substances, for example proteins. Further detection methods include waveguide spectroscopy, fluorescence, impedance spectroscopy, radiometric and electrical methods.

To produce the inventive functionalized porous carrier, any material can be used, provided that pores are formed on at least one of its surfaces, into which nanoparticles or nanoparticles with molecule-specific recognition sites can be introduced and thus enable functionalization of the porous material. The invention likewise envisages that the two opposite surfaces of the material have pores. The pores of the porous material used in accordance with the invention can, for example, extend from one surface through the material to the other surface. The pores of the upper side and the pores of the lower side can also be connected to one another by connecting channels. The pores of the porous material used in accordance with the invention can also extend only from one or both surfaces up to a certain depth of the material without reaching the opposite surface and without being connected to one another connecting channels. In a preferred embodiment, the pores and the pore walls of the inventive functionalized carrier are likewise provided with molecule-specific recognition sites.

The invention also envisages the alteration or modification of the pore structure of the porous material used to produce the inventive functionalized carrier before the pores are filled with nanoparticles. The pore structure of the porous material can be altered, for example, at predetermined sites, i.e. according to a predetermined pattern, by applying fine cut lines, by milling, engraving or diecutting, by destroying the pore structure by use of embossing or printing, etc. To form very fine and exact structures, a laser can also be used. With the aid of a laser beam, it is possible to obtain, on the surface of the porous material, ultrafine nonporous lines or regions by melting or ablation. In this way, it is possible to obtain a predetermined pattern on the surface of the porous material, the pore structure being destroyed in the regions hit by the laser beam.

The porous material used to produce the inventive functionalized may be self-supporting or non-self-supporting. If the porous material used is not self-supporting, it can be mounted on an additional carrier material, for example a nonporous carrier material or carrier of reduced porosity. “Reduced porosity” means that this surface of this material, in comparison to the surface of the porous material in whose pores nanoparticles are present in accordance with the invention, comprises significantly fewer pores per unit area and/or significantly smaller pores. For example, the non-self-supporting membrane used to produce the inventive functionalized carrier can be applied to a plastics film or plaque or to an inorganic carrier such as a glass or ceramic plaque. One example of a self-supporting porous membrane is an asymmetric polymeric membrane having a pore structure in which the pores extend from one surface through the membrane to the other surface, the diameter of the pores decreasing from one surface toward the opposite surface, so that only pores having a significantly smaller diameter, if any at all, are present on this opposite surface. The portion of the membrane which has only few pores, if any, functions as the carrier for the porous membrane regions.

In preferred embodiments, the porous material used to produce the inventive functionalized carrier is a membrane, especially a microporous membrane. “Microporous material” or “microporous membrane” is understood to mean a material or a membrane in which the pores present on the surface have a mean diameter of about 0.001 to about 100 μm, preferably about 0.01 to about 30 μm.

In a particularly preferred embodiment, the inventive functionalized carrier comprises a porous, especially microporous, inorganic or organic membrane. The microporous inorganic membrane used in accordance with the invention consists preferably of ceramic, glass, silicon, metal, metal oxide or a mixture thereof, or comprises it or them. In particularly preferred embodiments, the inorganic microporous membrane consists of aluminum oxide, zirconium oxide or a mixture thereof, or comprises it or them. Inorganic membranes can advantageously be stressed at temperatures up to 400° C., in some cases even up to 900° C. Inventive functionalized carriers based on a microporous inorganic membrane can therefore be used in particular for those applications in which high temperatures are used.

The microporous organic membrane used in accordance with the invention consists preferably of a polyamide, polyvinylidene fluoride, a polyether sulfone, a polysulfone, a polycarbonate, polypropylene, cellulose acetate, cellulose nitrite, a cellulose with a chemically modified surface or a mixture thereof, or comprises it or them.

A further embodiment of the inventive functionalized carrier envisages that, on at least one porous surface of the carrier, at least one separating layer which prevents the ingress of relatively large undesired particles, for example matrix particles, into the pores comprising nanoparticles is additionally applied. In a preferred embodiment, in each case more than one separating layer may be present on the two porous surfaces.

The invention envisages that the functionalized carrier may be formed either in an unstructured or structured manner. A preferred embodiment of the invention relates to an unstructured functionalized carrier, all or virtually all pores of the porous surface of the inventive functionalized carrier being filled uniformly with nanoparticles having molecule-specific recognition sites. The porous material preferably has continuous pores, i.e. pores which extend from one surface through the porous material to the opposite surface. Such an unstructured functionalized carrier is suitable in particular as a flow device, especially for the removal and/or isolation of specific molecules from a liquid medium.

A further particularly preferred embodiment of the invention relates to a structured functionalized carrier which is characterized in that the porous surface of the inventive functionalized carrier has a plurality of defined regions arranged according to a predetermined pattern, in which the pores comprise nanoparticles, especially nanoparticles with molecule-specific recognition sites. These defined regions have, in particular, a defined shape and a defined size. Such regions may, for example, have a punctiform or linear structure.

A particularly preferred embodiment envisages that these individual regions which comprise nanoparticles, for example nanoparticles with molecule-specific recognition sites, are separated from one another by nonporous zones or zones of at least lower porosity, i.e. zones which do not comprise pores with nanoparticles. These zones too, which have no regions comprising nanoparticles or no pores at all, have a defined shape and size. Such a predefined structure which has defined regions with pores in which, for example, nanoparticles having molecule-specific recognition sites are present, these regions being separated from one another by defined zones which comprise no pores or no nanoparticles, can be obtained, for example, when the inventive functionalized carrier is produced by using a porous material whose pore structure, on the surface, has been altered according to a predefined pattern, so that regions with pores and pore-free zones are generated. The nanoparticles, especially the nanoparticles provided with molecule-specific recognition sites, are then subsequently applied to the pretreated porous material.

A further preferred embodiment envisages that these individual regions which comprise nanoparticles, for example nanoparticles with molecule-specific recognition sites, are separated from one another by zones which are covered with a preferably nonporous film.

Yet another preferred embodiment envisages that these individual regions preferably comprise nanoparticles with molecule-specific recognition sites and are separated from one another by porous zones in whose pores nanoparticles without molecule-specific recognition sites are present. In this case, the nanoparticles without molecule-specific recognition sites have preferably been modified with a polyethylene glycol to prevent unspecific binding.

Yet another preferred embodiment envisages that these individual regions which comprise nanoparticles, for example nanoparticles with molecule-specific recognition sites, are separated from one another by porous zones, the zones being chemically modified to prevent unspecific binding, for example with a polyethylene glycol or with a hydrophobic perfluoroalkyl compound such as a silane. To minimize the contact of a sample liquid with these zones, the surfaces of these zones can also be configured as superhydrophobic surfaces.

According to the invention, the possibility exists of introducing the same nanoparticles, for example nanoparticles with the same molecule-specific recognition sites and/or the same immobilized organic molecule into the pores of all defined regions in which nanoparticles, especially nanoparticles with molecule-specific recognition sites, are to be present. According to the invention, the possibility also exists of introducing different nanoparticles, for example nanoparticles with different molecule-specific recognition sites and/or different immobilized organic molecules into the pores of the individual defined regions.

The present invention therefore relates to structured functionalized porous carriers having a plurality of defined regions, the same nanoparticles being present in the pores of all regions, and the regions comprising nanoparticles preferably being separated from one another by zones which have no pores or no pores comprising nanoparticles. The present invention also relates to structured functionalized porous carriers having a plurality of defined regions, the individual regions having different nanoparticles, and the regions comprising nanoparticles preferably being separated from one another by zones which have no pores or no pores comprising nanoparticles. Such structured functionalized carriers are suitable in particular for use as a microarray.

In a further embodiment, the invention envisages that the nanoparticles present in the pores are additionally fixed within the pores by a bonding agent. The bonding agent used is preferably a substance which has charged or uncharged chemically reactive groups. The bonding agent serves in particular to bond the nanoparticles in a fixed manner to the pore walls of the porous material. The selection of the bonding agent is guided by the porous carrier material used and the nanoparticles to be bound. Of course, it is also possible to use a plurality of different bonding agents, for example when different nanoparticles are to be fixed in individual porous regions of the carrier, i.e. when individual regions of the carrier are to be functionalized differently. In a further preferred embodiment of the invention, bonding agents may be used whose properties, for example cohesion properties, can be changed by an external stimulus and which are therefore controllable externally. For example, the cohesion properties of the bonding agent can be reduced by a change in the pH, in the ion concentration and/or in the temperature to such an extent that the nanoparticles bonded in the pores using the bonding agent are released and can optionally be transferred into the pores of another porous material.

In the context of the present invention, a “nanoparticle” is understood to mean a particulate binder matrix which, in a preferred embodiment, has molecule-specific recognition sites comprising first functional chemical groups. The nanoparticles used in accordance with the invention comprise a core with a surface. The molecule-specific recognition sites comprising first functional groups are arranged on the surface or can be arranged thereon. The first functional groups are capable of binding complementary second functional groups, for example of an organic molecule, in a covalent or noncovalent manner. Interaction between the first and second functional groups immobilizes the organic molecule on the nanoparticle and hence within the pores of the porous carrier, or can immobilize it thereon. The nanoparticles used in accordance with the invention to produce the functionalized porous carrier have a size of about 5 nm to 1000, preferably less than 500 nm.

The invention also envisages that the organic molecule, preferably biologically active molecule, is bound or immobilized, or can be bound or immobilized, on the surface of the nanoparticles, if appropriate with retention of its biological activity. In a preferred embodiment, the organic molecule, especially biologically active molecule, may be or become bound in a directional manner. Directional immobilization is advantageous for a series of uses of the inventive functionalized carrier, but is not a necessary condition. Even when a large percentage of the molecules immobilized on the nanoparticle is immobilized in an undirectional manner, so that the molecules, for example, exhibit no activity, this is compensated for by the very large surface area provided in accordance with the invention and the great enrichment of the molecules enabled thereby.

The biological activity of a molecule is understood to mean all functions that it exerts in an organism in its natural cellular environment. When the molecule is, for example, a protein, the biological activity may, for example, include specific catalytic or enzymatic functions, functions in immune defense, regulation functions, and the like. When the molecule is a nucleic acid, the biological function may consist, for example, in the coding of a gene product, or in the nucleic acid being usable as a binding motif for regulatory proteins. “Retention of the biological activity” means that a biological molecule, after immobilization on the surface of a nanoparticle, can exert the same or virtually the same biological functions at least to a similar degree as the same molecule in the unimmobilized state under suitable in vitro conditions, or the same molecule in its natural cellular environment.

In the context of the present invention, the term “immobilized directionally” or “directional immobilization” means that a molecule is or has been bound at the defined positions within the molecule on the molecule-specific recognition sites of a nanoparticle such that, for example, the three-dimensional structure of the domain(s) required for biological activity is unchanged compared to the unimmobilized state, and that this domain/these domains, for example binding pockets for cellular reactants, is/are freely accessible to them on contact with other native cellular reactants.

The invention envisages in particular that the biological molecule immobilizable or immobilized on nanoparticles of the inventive functionalized carrier is a protein, a nucleic acid or a fragment thereof. Nucleic acids may in particular be single- or double-strand DNA, RNA, PNA or LNA molecules.

In the context of the present invention, a “nucleic acid” is understood to mean a molecule which consists of at least two nucleotides bonded via a phosphodiester bond. Nucleic acids may be deoxyribonucleic acid molecules, ribonucleic acid molecules, PNA molecules and LNA molecules. The nucleic acid may be present either in single-strand or double-strand form. In the context of the present invention, a nucleic acid may thus also be an oligonucleotide. According to the invention, the bound nucleic acid or nucleic acid to be bound may be of natural or synthetic origin. According to the invention, the nucleic acid may also be modified compared to the wild-type nucleic acid by genetic engineering methods, and/or contain unnatural and/or unusual nucleic acid units. The nucleic acid may be bonded to molecules of another type, for example to proteins.

PNA (peptide nucleic acid or polyamide nucleic acid) molecules are molecules which are not negatively charged and act in the same way as DNA (Nielsen et al., Science, 254 (1991), 1497-1500; Nielsen et al., Biochemistry, 36 (1997), 5072-5077; Weiler et al., Nuc. Acids Res., 25 (1997), 2792-2799). PNA sequences comprise a basic polyamide skeleton composed of N-(2-aminoethyl)glycine units and do not possess any deoxyribose or ribose units or any phosphate groups. The different bases are bonded to the basic skeleton via methylene-carbonyl bonds. LNA (locked nucleic acid) molecules are characterized in that the furanose ring conformation is restricted by a methylene linker which connects the 2′-O position to the 4′-C position. LNAs are incorporated as individual nucleotides into nucleic acids, for example DNA or RNA. Just like PNA molecules, LNA oligonucleotides are subject to the Watson-Crick base pair rules and hybridize on complementary oligonucleotides. LNA/DNA or LNA/RNA duplex molecules exhibit increased thermal stability compared to similar duplex molecules which are formed exclusively from DNA or RNA.

In the context of the present invention, a “protein” is understood to mean a molecule which comprises at least two amino acids bonded together via an amide bond. In the context of the present invention, a protein may thus also be a peptide, for example an oligopeptide, a polypeptide or, for example, an isolated protein domain. Such a protein may be of natural or synthetic origin. The protein may be modified compared to the wild-type protein by genetic engineering methods and/or contain unnatural and/or unusual amino acids. The protein may be derivatized compared to the wild-type form, for example have glycosylations, it can be shortened, it can be fused with other proteins or with molecules of another type, for example to carbohydrates. According to the invention, a protein may in particular be an enzyme, a receptor, a cytokine, an antigen or an antibody.

In the context of the present invention, “antibody” means a polypeptide which is essentially encoded by one or more immunoglobulin genes, or fragments thereof, which specifically recognize(s) an analyte (antigen) and bind(s) thereto. Antibodies occur, for example, as intact immunoglobulins or as a series of fragments which are obtained by means of cleavage with various peptidases. “Antibodies” also means modified antibodies, for example oligomeric, reduced, oxidized and labeled antibodies. “Antibodies” also includes antibody fragments which have been obtained either by means of modification of whole antibodies or by means of de novo synthesis using DNA recombination techniques. The term “antibodies” includes both intact molecules and fragments thereof, such as Fab, F(ab)′)₂ and Fv, which can bind epitope determinants.

In the context of the present invention, “molecule-specific recognition sites” is understood to mean regions of the nanoparticles which enable specific interaction between the nanoparticle and organic, especially biologically active, molecules as target molecules. The interaction can be based on directional attractive interaction between one or more pairs from first functional groups of the nanoparticle and complementary second functional groups, which bind the first functional groups, of the target molecules, i.e. of the organic molecules. Individual interacting pairs of functional groups between nanoparticle and organic molecule are each arranged in a spatially fixed manner on the nanoparticle and the organic molecule. This fixing need not be a rigid arrangement but rather may be configured so as to be entirely flexible. The attractive interaction between the functional groups of the nanoparticles and of the organic molecules may be in the form of noncovalent bonds such as van der Waals bonds, hydrogen bonds, π-π bonds, electrostatic interactions or hydrophobic interactions. Also conceivable are reversible covalent bonds, as are mechanisms which are based on complementarity of the shape or form. The interactions envisaged in accordance with the invention between the molecule-specific recognition sites of the nanoparticles and the target molecule are thus based on directional interactions between the pairs of the functional groups and on the spatial arrangement of these groups which enter into pair formation relative to one another on the nanoparticle and the target molecule. This interaction leads to the immobilization of the molecule on the surface of the nanoparticles. The prior art also discloses further means of binding organic molecules on a surface. According to the invention, organic molecules may also be bound on the nanoparticle surfaces in other ways.

The invention thus envisages that the molecule-specific recognition sites comprise one or more first functional groups and the bound organic, preferably biologically active, molecules or the organic, preferably biologically active, molecules to be bound comprise complementary second functional groups which bind the first functional groups. In a preferred embodiment of the present invention, the first functional groups, which are part of the molecule-specific recognition sites on the surface of the nanoparticle or form them, and the complementary second functional groups which bind the first functional groups are selected from the group consisting of active ester, alkyl ketone group, aldehyde group, amino group, carboxyl group, epoxy group, maleimido group, hydrazine group, hydrazide group, thiol group, thioester group, oligohistidine group, Strep-Tag I, Strep-Tag II, desthiobiotin, biotin, chitin, chitin derivatives, chitin-binding domains, metal chelate complex, streptavidin, streptactin, avidin and neutravidin.

The invention also envisages that the molecule-specific recognition site encompasses a relatively large molecule, such as a protein, an antibody, etc., which comprises the first functional groups.

The molecule-specific recognition site may also be a molecular complex which consists, for example, of a plurality of proteins and/or antibodies and/or nucleic acids, at least one of these molecules comprising the first functional groups. A protein may comprise, as a molecule-specific recognition sequence, for example, an antibody and a protein bonded thereto. The antibody may also comprise a streptavidin group or a biotin group. The protein bonded to the antibody may be a receptor, for example an MHC protein, cytokine, a T-cell receptor such as the CD8 protein, or receptors which can bind a ligand. A molecular complex may, for example, also comprise a plurality of proteins and/or peptides, for example a biotinylated protein, which binds a further protein and additionally a peptide in a complex. The first and second functional groups may be obtained, for example, by molecular imprinting.

A nanoparticle present in accordance with the invention in the pores of a functionalized porous carrier thus has, on its surface, a first functional group which is bonded covalently or noncovalently to a second functional group of a molecule to be immobilized, the first functional group being a different group from the second functional group. The two groups which become bonded to one another must be complementary to one another, i.e. be capable of entering into a covalent or noncovalent bond with one another.

When, for example, in accordance with the invention, the first functional group used is an alkyl ketone group, in particular methyl ketone or aldehyde group, the second functional group is a hydrazine or hydrazide group. When, conversely, a hydrazine or hydrazide group is used as the first functional group, the second functional group is, in accordance with the invention, an alkyl ketone, especially methyl ketone, or aldehyde group. When, in accordance with the invention, a thiol group is used as the first functional group, the second complementary functional group is a thioester group. When the first functional group used is a thioester group, the second functional group, in accordance with the invention, is a thiol group. When, in accordance with the invention, the first functional group used is a metal ion chelate complex, the second functional complementary group is an oligohistidine group. When the first functional group is an oligohistidine group, the second functional complementary group is a metal ion chelate complex.

When the first functional group used is Strep-Tag I, Strep-Tag II, biotin or desthiobiotin, the second complementary functional group used is streptavidin, streptactin, avidin or neutravidin. When the first functional group used is streptavidin, streptactin, avidin or neutravidin, the second complementary functional group used is Strep-Tag I, Strep-Tag II, biotin or desthiobiotin.

When, in a further embodiment, chitin or a chitin derivative is used as the first functional group, the second functional complementary group used is a chitin binding domain. When the first functional group used is a chitin binding domain, the second functional complementary group used is chitin or a chitin derivative.

The aforementioned first and/or second functional groups may, in accordance with the invention, be bonded with the aid of a spacer to the molecule to be immobilized or the nanoparticle core, or introduced by means of a spacer onto the nanoparticle core or into the molecule. The spacer thus serves firstly as a spacer of the functional group from the core or from the molecule to be immobilized, secondly as a carrier for the functional group. Such a spacer may, for example, comprise alkylene groups or ethylene oxide oligomers having from 2 to 50 carbon atoms, which are, for example, substituted and have heteroatoms.

A preferred embodiment of the invention envisages that the second functional groups are a natural constituent of the immobilized molecule or molecule to be immobilized. When the molecule is, for example, a protein of average size, i.e. of a size of from about 50 kDA with about 500 amino acids, it contains from about 20 to 30 reactive amino groups which are in principle useful as a second functional group for immobilization. In particular, they are the amino group at the N-terminal end of a protein. All other free amino groups, especially those of the lysine radicals, in proteins are also useful for the immobilization. It is equally possible to use arginine with its guanidium group or cysteine as the functional group.

The invention further envisages the introduction of the second functional groups into the molecule to be immobilized by means of genetic engineering methods, biochemical, enzymatic and/or chemical derivatization or chemical synthesis methods. The derivatization should be effected such that any biological activity present in the molecule is preserved after the immobilization.

When the molecule to be immobilized is a protein, it is possible, for example, to introduce unnatural amino acids into the protein molecule, for example together with spacers or linkers, by genetic engineering methods or during a chemical protein synthesis. Such unnatural amino acids are compounds which have an amino acid function and an R radical and are not defined by a naturally occurring genetic code, these amino acids more preferably having a thiol group.

In a further preferred embodiment of the present invention, functional groups can be introduced into the molecule to be immobilized, especially protein, by modification, by adding tags, i.e. labels, to the protein, preferably on the C-terminus or the N-terminus. However, these tags may also be arranged intramolecularly. In particular, it is envisaged that a protein is modified by adding at least one Strep-Tag, for example a Strep-Tag I or Strep-Tag II, or biotin. According to the invention, a Strep-Tag is also understood to mean functional and/or structural equivalents, provided that they can bind streptavidin groups and/or equivalents thereof. In the context of the present invention, the term “streptavidin” thus also includes its functional and/or structural equivalents. According to the invention, it is also possible to modify a protein by adding an His-Tag which comprises at least 3 histidine radicals, but preferably an oligohistidine group. The His-Tag introduced into the protein may then bind to a molecule-specific recognition site which includes a metal chelate complex.

A preferred embodiment of the invention thus envisages the bonding of proteins which are modified, for example, with unnatural amino acids, natural but unnaturally derivatized amino acids or specific Strep-Tags, or antibody-bound proteins, with reactive nanoparticle surfaces complementary thereto such that suitable specific, especially noncovalent, attachment of the proteins is effected, and thus directional immobilization of the proteins onto the surface. According to the alignment of the biologically active molecules via Tag binding sites, these molecules may additionally be bound covalently, for example also with a crosslinker such as glutaraldehyde. This makes the protein surfaces more stable.

The nanoparticles used to produce the inventive functionalized porous carriers have a core on which the surface with the molecule-specific recognition sites is arranged. In the context of the present invention, a “core” of a nanoparticle is understood to mean a chemically inert substance which serves as the carrier for the molecule to be immobilized. According to the invention, the core is a compact or hollow particle having a size of from 5 nm to 1000 nm.

In a preferred embodiment of the present invention, the core of the nanoparticles used in accordance with the invention consists of an inorganic material such as a metal, for example Au, Ag or Ni, silicon, SiO₂, SiO, a silicate, Al₂O₃, SiO₂.Al₂O₃, Fe₂O₃, Ag₂O, TiO₂, ZrO₂, Zr₂O₃, Ta₂O₅, zeolite, glass, indium tin oxide, hydroxylapatite, a Q-dot or a mixture thereof, or comprises them.

In a further preferred embodiment of the invention, the core of the nanoparticles used in accordance with the invention consists of an organic material, or comprises it. The organic material is preferably a polymer, for example polypropylene, polystyrene, polyacrylate, a polyester of lactic acid or a mixture thereof.

The cores of the nanoparticles used in accordance with the invention can be produced using customary methods known in the technical field, for example sol-gel synthesis methods, emulsion polymerization, suspension polymerization, etc. After the cores have been produced, the surfaces of the cores are provided with the specific first functional groups by chemical modification reaction, for example using customary methods such as graft polymerization, silanization, chemical derivatization, etc. One means of obtaining surface-modified nanoparticles in one step consists in the use of surfmers in the emulsion polymerization. A further means is molecular imprinting.

“Molecular imprinting” is understood to mean the polymerization of monomers in the presence of templates which, with the monomer, can form a complex which is relatively stable during the polymerization. After the templates have been washed out, the materials thus produced can again specifically bind template molecules, molecule species structurally related to the template molecules, or molecules which have groups structurally related or identical to the template molecules or parts thereof. A template is therefore a substance present in the monomer mixture during the polymerization, for which the polymer formed has an affinity.

Particular preference is given in accordance with the invention to producing surface-modified nanoparticles by means of emulsion polymerization using surfmers. Surfmers are amphiphilic monomers (surfmer=Surfactant+Monomer), which can be copolymerized on the surface of latex particles and stabilize them. Reactive surfmers additionally possess functionalizable end groups which can be reacted under mild conditions with nucleophiles such as primary amines (amino acids, peptides, proteins), thiols or alcohols. In this way, a multitude of biologically active polymeric nanoparticles is obtainable. Publications which give an account of the prior art and means and limitations of the use of surfmers are described in U.S. Pat. No. 5,177,165, U.S. Pat. No. 5,525,691, U.S. Pat. No. 5,162,475, U.S. Pat. No. 5,827,927 and JP 4 018 929.

The density of the first functional groups and the distance of these groups from one another can, in accordance with the invention, be optimized for each molecule to be immobilized. The environment of the first functional groups on the surface can also be prepared in a corresponding manner with regard to highly specific immobilization of a biologically active molecule.

A preferred embodiment of the invention envisages the anchoring of additional functions in the nanoparticle core which enable simple detection of the nanoparticle cores and hence of the structures formed by the nanoparticles in the pores of the inventive functionalized carrier using suitable detection methods. These additional functions may, for example, be fluorescence labels, UV/VIS labels, superparamagnetic functions, ferromagnetic functions and/or radioactive labels. Suitable methods for detecting nanoparticles include, for example, fluorescence or UV-VIS spectroscopy, fluorescence or light microscopy, MALDI mass spectroscopy, waveguide spectroscopy, impedance spectroscopy, electrical and radiometric methods.

A further embodiment envisages that the surfaces of the cores can be modified by applying additional functions such as fluorescence labels, UV/VIS labels, superparamagnetic functions, ferromagnetic functions and/or radioactive labels. Yet a further embodiment of the invention envisages that the core of the nanoparticles can be surface-modified with an organic or inorganic layer which has the first functional groups and the above-described additional functions.

A further embodiment of the invention envisages that the surface of the cores has chemical compounds which serve to sterically stabilize and/or to prevent a change in conformation of the immobilized molecules and/or to prevent the addition of further organic compounds onto the core surface. These chemical compounds are preferably a hydrogel, a polyethylene glycol, an oligoethylene glycol, dextran or a mixture thereof.

According to the invention, it is also possible that ion exchange functions are anchored separately or additionally on the surface of the nanoparticle cores. Nanoparticles with ion exchange functions are suitable in particular for optimizing the MALDI analysis, since they can bind disruptive ions.

Yet a further embodiment of the invention envisages that the organic molecule immobilized on the surface of the nanoparticles used in accordance with the invention itself has labels which enable simple detection of the immobilized molecules using suitable detection methods. These labels may, for example, be a fluorescent label, a UV/VIS label, a superparamagnetic function, a ferromagnetic function and/or a radioactive label. As detailed above, useful detection methods for these labels present in the immobilized biological molecule are, for example, fluorescence or UV-VIS spectroscopy, MALDI mass spectroscopy, waveguide spectroscopy, impedance spectroscopy, electrical and radiometric methods.

The present invention likewise relates to processes for producing the inventive functionalized porous carrier, wherein a suspension of nanoparticles is applied to the surface of a porous carrier material. Using suitable suspension media, it is possible in a very simple manner to obtain, from nanoparticles, stable suspensions which behave like solutions. Owing to the inventive use of, preferably, materials with pores whose size is in the micrometer range, for example microporous membranes, the nanoparticles penetrate relatively easily into the pores of the material. After the nanoparticles have penetrated into the pores of the material, the nanoparticles which have not penetrated into the pores and the residual suspension are then removed, for example by flushing and then drying the now functionalized carrier material.

The nanoparticles of the suspension applied to the surface of the porous carrier material may have molecule-specific recognition sites or organic molecules already bound thereto. Accordingly, it is possible using the process according to the invention to produce functionalized carriers which have nanoparticles without molecule-specific recognition sites, or functionalized carriers which have nanoparticles with molecule-specific recognition sites, or functionalized carriers which nanoparticles with organic molecules bound thereto. When a functionalized carrier which comprises nanoparticles without molecule-specific recognition sites is produced, the nanoparticles present in the pores of the carrier can be provided subsequently with molecule-specific recognition sites. When a functionalized carrier which comprises nanoparticles with molecule-specific recognition sites is produced, organic molecules can be bound subsequently on the recognition-specific recognition sites of the nanoparticles. It will be appreciated that it is also possible to produce functionalized carriers with differently functionalized nanoparticles, for example carriers which have regions with nanoparticles without molecule-specific recognition sites and/or regions with nanoparticles having molecule-specific recognition sites and/or regions with nanoparticles to which organic molecules are bonded.

When an unstructured functionalized carrier is to be produced, in which, for example, all pores of the surface are to comprise the same nanoparticles, the nanoparticle suspension can be applied, for example, by immersing the porous material into the nanoparticle suspension, or by pouring the nanoparticle suspension on the porous carrier and then distributing it uniformly. The porous material can also be impregnated with the nanoparticle suspension.

If a structured functionalized carrier is to be produced, i.e. a carrier on whose surface regions with pores comprising nanoparticles are arranged and are separated from one another by zones without pores comprising nanoparticles, the nanoparticle suspension can also be applied by using a conventional spotter device using a mask or a die. Using spotter devices, it is also possible to apply different nanoparticle suspensions, in order thus to produce functionalized carriers which have defined regions with different nanoparticles, for example regions with nanoparticles on which a nucleic acid can be immobilized, and regions on which a protein can be immobilized.

A preferred embodiment of the process according to the invention envisages that the porous material, before the nanoparticle suspension is applied, is subjected to a treatment to change the pore structure at predetermined sites. This can be done, for example, by applying fine cut lines, by milling, engraving, diecutting, by destroying the pore structure, by using embossing or printing steps, etc. It is likewise possible in accordance with the invention to destroy the pore structure of the porous carrier material at predetermined sites using a laser, in which case it is possible to obtain, with the aid of the laser beam, ultrafine nonporous lines and regions by melting, for example in the case of thermoplastic materials, or ablation, for example in the case of thermoplastic or nonmeltable materials, on the porous material surface. Such a pretreatment of the porous material surface allows a predetermined pattern to be burnt into the porous material, so that the pore structure in the regions hit by the laser beam is destroyed.

A further embodiment of the process for producing the inventive functionalized carrier also envisages the treatment of the porous surface of the carrier material before the application of the nanoparticle suspension with a solution, suspension or dispersion of a bonding agent such that it can penetrate into the pores of the material. The bonding agent which is present on the surface of the material but not in the pores is then removed using suitable treatment steps. The bonding agent present in the pores serves to improve the adhesion of the nanoparticles within the pore walls.

The present invention also relates to functional elements which comprise at least one inventive functionalized porous carrier. In the context of the present invention, a “functional element” is understood to mean an element or a device which, either alone or as part of a more complex device, i.e. in conjunction with further similar functional elements or those of another type, exerts at least one defined function. According to the invention, a functional element comprises at least one porous carrier with a carrier surface, in at least some of whose pores are arranged defined nanoparticles in a structured or unstructured manner, the nanoparticles being provided with, and/or it being possible to provide the nanoparticles with, organic molecules, especially molecules having biological functions, for example biologically active molecules such as nucleic acids, proteins, PNA molecules and/or LNA molecules.

In its simplest embodiment, the functional element produced in accordance with the invention is therefore an inventive functionalized porous carrier, especially a functionalized carrier which comprises a self-supporting microporous membrane.

In a preferred embodiment, the functional element comprises, in addition to the inventive functionalized carrier, at least one further constituent which is, for example, a second inventive functionalized carrier or a carrier composed of a nonporous material or a material with a reduced porosity. In the context of the present invention, a material with reduced porosity is a material whose surface area, in comparison to the surface area of the porous material of the inventive functionalized carrier, contains significantly fewer pores per unit surface area and/or significantly smaller pores.

The present invention relates in particular to a functional element, wherein the at least one inventive functionalized carrier is arranged on the surface of a nonporous material or of a material with reduced porosity. A carrier composed of a nonporous material or a material with reduced porosity is a solid matrix which serves, for example, as a means of attachment to the inventive functionalized carrier and imparts additional mechanical stability to it. The carrier composed of the nonporous material or material with reduced porosity, on whose surface the at least one functionalized carrier is arranged, may have any size and any shape, for example that of a sphere, of a cylinder, of a rod, of a wire, of a plate or of a film. The carrier composed of the nonporous material or material with reduced porosity may be either a hollow body or a solid body. A solid body means in particular a body which has essentially no cavities and may consist entirely of one material, for example a nonporous material or a material of reduced porosity, or of a combination of such materials. The solid body may also consist of a layer sequence of identical or different nonporous materials or materials of relatively low porosity.

In a particularly preferred embodiment, the nonporous material or the material of relatively low porosity may be a metal, a metal oxide, a polymer, glass, a semiconductor material, ceramic and/or a mixture thereof. In the context of the invention, this means that the carrier formed from the nonporous material or the material with low porosity consists entirely of one of the aforementioned materials, or essentially comprises them, or consists entirely of a combination of these materials, or essentially comprises it, or that at least the surface of such a carrier consists entirely of one of the aforementioned materials, or essentially comprises them, or consists entirely of a combination of these materials, or essentially comprises it. The invention also envisages that the surface of the carrier formed from the nonporous material or the material with relatively low porosity is planar or else prestructured, for example contains feed and removal lines.

A preferred embodiment of the inventive functional element envisages the coverage by the at least one functionalized carrier of the entire surface of the carrier composed of the nonporous material or the material with low porosity.

A further embodiment of the inventive functional element envisages that the at least one functionalized carrier covers a plurality of surface sections arranged according to a predetermined pattern or regions of the surface of the carrier composed of the nonporous material or the material with low porosity. In this embodiment, a plurality of regions which comprise an inventive functionalized carrier are thus arranged on the surface of the carrier formed from a nonporous material or material with reduced porosity. These regions are surrounded by zones which consist of the nonporous carrier material or carrier material with reduced porosity, and are preferably also delimited from one another by these nonporous zones or zones of reduced porosity.

In one embodiment, the individual sections of the surface of the nonporous material or material with reduced porosity may be covered with the same inventive functionalized carrier. In a further embodiment, the individual sections of the surface of the nonporous material or material with reduced porosity may be covered with different functionalized carriers. The different functionalized carriers may, for example, comprise nanoparticles with different molecule-specific recognition sites and/or nanoparticles with different bound organic, especially biologically active, molecules.

A further preferred embodiment of the invention relates to a functional element, wherein the at least one functionalized carrier is arranged in or on a frame composed of a nonporous material or a material with reduced porosity. The frame composed of the nonporous material or material of relatively low porosity can thus, for example, be placed on the inventive functionalized porous carrier and be, for example, adhesive-bonded to it or bonded to it in another way. The inventive functionalized carrier may also be clamped into the frame. The frame may additionally have supporting elements, for example in the form of a grid, so that the surface of the functionalized carrier enclosed by the frame is interrupted by the supporting elements which are connected to the frame and are composed of a nonporous material or a material with reduced porosity.

In a preferred embodiment, the inventive functional element is a microtiter plate or test plate with at least one depression, cavity or reaction chamber, but preferably with several depressions which can be used for a multitude of different analytical or diagnostic purposes.

In a preferred embodiment, the inventive microtiter plate has from at least 1 to 96 reaction chambers. Even more preferably, the inventive microtiter plate has even more reaction chambers, for example 1536 reaction chambers. The inventive microtiter plates can be used for a multitude of analytical or diagnostic test systems using chemical, biological or biochemical materials, which include, for example, the chemical analysis of samples, the performance of chemical reactions, the preparation of samples for spectroscopic analyses, the cultivation of cells, the detection and/or the quantification of biologically active molecules such as proteins or nucleic acids, the performance of diagnostic tests for the detection of microorganisms or for the detection of antibodies, the performances of analyses on liquid samples, especially immunological, virological or serological screening analyses, the performance of radioimmunoassays, the performance of test series regarding the effectiveness of medically active ingredients, etc., but without any restriction thereto. The inventive microtiter plates may also be used to perform combinatorial chemistry processes, for example for the synthesis of organic compounds, for example peptides or proteins.

One embodiment of the invention envisages that the entire surface of the microtiter plate consists of at least one inventive functionalized carrier or comprises it. A further embodiment of the inventive microtiter plate envisages that the reaction chambers or at least parts of the reaction chambers, for example the base, the side walls or the base and the side walls of the reaction chambers, consist of at least one inventive functionalized carrier or comprise it.

When only the base of the reaction chambers of the inventive microtiter plate consists of the functionalized carrier and the functionalized carrier has a porous material with continuous pores, the microtiter plate may, in accordance with the invention, also be used as a flow device. For example, the synthesis of an organic molecule, for example peptide, from individual amino acid units can be performed on the nanoparticles present in the pores. In this case, the first amino acid unit in a solution is first introduced into the reaction chambers. Once the first unit has passed into the pores, it can be immobilized on the nanoparticles by binding to the molecule-specific recognition sites of the nanoparticles present in the pores of the functionalized carrier. Excess amounts of the first amino acid unit can then, if appropriate together with other reagents such as salts, etc., be drained via the pores, which extend through the functionalized carrier up to the opposite surface, and be removed therefrom. The first amino acid unit can be removed from the functionalized carrier, for example, by suitable wash steps using suitable wash solutions. The excess first unit and/or certain reagents can also be removed efficiently by applying a vacuum. Subsequently, the second amino acid unit is introduced into the reaction chambers and, after it penetrates into the pores, is coupled to the first immobilized amino acid unit under suitable reaction conditions. The excess second unit is then, if appropriate together with other reagents, likewise removed from the functionalized carrier. In this way, the complete desired organic molecule, for example the peptide, can be synthesized, while excess reactants or waste products can simultaneously be removed from the pores of the functionalized carrier.

In a further preferred embodiment, the inventive functional element is a microarray device. In the context of the present invention, “microarray device” is understood to mean a device which comprises immobilized cells, cell fragments, tissue parts or molecules in the form of spots, which are preferably arranged in an ordered pattern, on a solid matrix. The immobilized molecules are in particular molecules such as nucleic acids, oligonucleotides, proteins, peptides, antibodies or fragments thereof. Such a microarray device is also referred to as a biochip. The inventive microarray device is preferably a nucleic acid chip or a protein chip.

The invention envisages that the inventive microarray has, per 1 cm² of area, from about 5 to about 1 000 000, preferably from about 20 to about 100 000 spots, i.e. separate regions separated from one another on which nucleic acids, oligonucleotides, proteins, peptides, antibodies, etc., are immobilized.

One embodiment of the invention envisages that the entire surface of the inventive microarray device consists of at least one inventive functionalized carrier, or comprises it. In this case, preference is given to using an inventive functionalized carrier whose pore structure, before its production, has been modified or destroyed using suitable processes, for example a laser, according to a predetermined pattern, so that nonporous lines or regions which delimit the porous regions comprising nanoparticles from one another are present on the surface of the functionalized carrier.

A further embodiment of the inventive microarray device envisages that, on the surface of the inventive microarray device, only certain regions which are delimited from one another and are arranged in a predefined pattern on the surface of the inventive microarray device consist of at least one inventive functionalized carrier or comprise it.

The inventive microarray device may, for example, be used to analyze ESTs (expressed sequence tags), to identify and characterize genes or other functional nucleic acids or proteins, but without any restriction thereto.

In a further preferred embodiment, the inventive functional element is an electronic component in a biocomputer. Such an electronic component may, for example, find use as a molecular circuit, etc., in medical technology or in a biocomputer. The inventive functional element is more preferably in the form of an optical store in optical information processing, in which case the inventive functional element comprises in particular immobilized photoreceptor proteins which can convert light directly to a signal.

In a further preferred embodiment, the inventive functional element is a flow device which can be used, for example, for the controlled removal and/or isolation of compounds from a liquid, for example a biological sample, but also to purify the liquid. The inventive flow device comprises at least one inventive functionalized carrier, wherein the pores of the at least one carrier extend from one surface through the carrier to the opposite surface and are thus continuous.

The inventive flow device can be used either to purify a solution, which selectively removes certain constituents present in the solution, or else to isolate and/or purify certain compounds present in the solution. The inventive flow device is flowed through by a liquid or solution which comprises at least one substance or else a complex mixture of different substances. As it flows through the flow device, the solution passes into the pores of the inventive functionalized carrier. The compound which is present in the solution and is to be isolated is immobilized selectively on the nanoparticles present in the pores of the carrier and thus removed from the solution, while the solution, i.e. the liquid medium, together other constituents of the solution, passes through the pores unhindered. In this way, it is possible to selectively remove at least one constituent of the solution supplied therefrom.

In a preferred embodiment of the inventive device, the at least one inventive functionalized carrier is arranged on a frame composed of a nonporous material or a material with reduced porosity. The at least one functionalized carrier may be unstructured in one embodiment, i.e. all or virtually all pores of the porous surface of the functionalized carrier are filled uniformly with nanoparticles having molecule-specific recognition sites. In the case that the inventive flow device is to be used to purify a solution, i.e. to remove a plurality of substances from the solution with the aim of obtaining a solution freed of certain substances, different nanoparticles which have, for example, different molecule-specific recognition sites may be present in each pore of the unstructured functionalized carrier, so that, as the solution passes through the functionalized carrier, a plurality of substances can be removed from the solution in one step. It will be appreciated that it is also possible that the pores of the unstructured functionalized carrier are filled uniformly with identical nanoparticles, for example in order to remove only one substance or one substance class from the solution and, if appropriate, also to enrich them. According to the invention, it is also possible that the inventive flow device also comprises a structured functionalized carrier with continuous pores. Some embodiments of the inventive flow device also envisage that at least one separating layer which prevents relatively large undesired particles present in the solution, for example matrix particles, from entering the pores and possibly blocking them is applied on the surface of the functionalized carrier.

A further embodiment of the inventive flow device envisages that a plurality of identical and/or different functionalized carriers are connected in series, in order, for example, to remove a plurality of different substances from a solution or in order to increase the efficiency of the removal and/or enrichment of a substance.

The inventive flow device preferably comprises a unit for generating a vacuum. When a vacuum is generated, the solution can flow through the inventive functionalized carrier more rapidly and efficiently.

The present invention likewise relates to the use of an inventive functionalized carrier for producing a functional element, for example a flow device, a microtiter plate, a microarray or an electronic component.

The present invention also relates to the use of the inventive porous carrier or of the functional elements produced using the inventive carrier to analyze an analyte in a sample and/or to isolate it and/or purify it from a sample. The inventive functional element in this case is preferably a nucleic acid array, protein array or a microtiter plate. In the context of the present invention, an “analyte” is understood to mean a substance for which the type and amount of its individual constituents are to be determined and/or which are to be removed from mixtures. In particular, the analyte is a protein, carbohydrate and the like. In a preferred embodiment of the invention, the analyte is a protein, peptide, active ingredient, harmful substance, toxin, pesticide, antigen or a nucleic acid. A “sample” is understood to mean an aqueous or organic solution, emulsion, dispersion or suspension which comprises an above-defined analyte in isolated and purified form or as a constituent of a complex mixture of different substances. A sample may, for example, be a biological liquid such as blood, lymph, tissue fluid, etc., i.e. a liquid which has been taken from a living or dead organism, organ or tissue. However, a sample may also be a culture medium, for example a fermentation medium, in which organisms, for example microorganisms, or human, animal or plant cells have been cultivated. A sample in the context of the invention may, however, also be an aqueous solution, emulsion, dispersion or suspension of an isolated and purified analyte. A sample may already have been subjected to purification steps, but may also be present in unpurified form.

The present invention therefore also relates to the use of the inventive functionalized carrier or of a functional element produced using the inventive carrier for performing analysis and/or detection methods, these methods being, for example, MALDI mass spectroscopy, fluorescence or UV-VIS spectroscopy, fluorescence or light microscopy, waveguide spectroscopy or an electrical method such as impedance spectroscopy. The analysis or detection method may also be an enzymatic process, for example using a peroxidase, galactosidase or an alkaline phosphatase.

The present invention likewise relates to the use of the inventive functionalized carrier or of a functional element produced using this inventive carrier for cultivating cells or for controlling cell adhesive or cell growth.

The present invention likewise relates to the use of the inventive functionalized porous carrier or of a functional element produced using the inventive functionalized carrier for the detection and/or for the isolation of organic, especially biologically active, molecules. For example, an inventive functionalized carrier in whose pores nanoparticles with immobilized single-strand nucleic acids are present can be used to detect a complementary nucleic acid in a sample and/or to isolate this complementary nucleic acid from a sample. For example, an inventive functionalized carrier which comprises a protein immobilized on nanoparticles, or a functional element produced using this carrier, can be used to detect and/or to isolate a protein which interacts with the immobilized protein from a sample.

The present invention also relates to the use of an inventive functionalized carrier or of a functional element produced therefrom for the development of pharmaceutical formulations. The invention likewise relates to the use of the inventive functionalized carriers or of the functional elements produced therefrom for investigating the effects and/or side effects of pharmaceutical formulations.

The inventive functionalized carriers or functional elements produced therefrom can likewise be used for the diagnosis of disorders, for example for the identification of pathogens and/or for the identification of mutated genes which lead to the development of disorders. The inventive functionalized carriers or the functional elements produced therefrom may also be used for the identification of diagnostically relevant metabolites, for example of glucose in urine.

The inventive functionalized carriers or functional elements produced therefrom can likewise be used for the online or offline monitoring of fermentation processes.

A further possible use of the inventive functionalized carriers or of the functional elements produced therefrom consists in the analysis of microbiological contaminants of surface water, groundwater and soil. The inventive functionalized carriers or the functional elements produced therefrom can likewise be used for the analysis of microbiological contaminations of foods or animal feeds.

A further preferred use of the inventive functionalized carriers or of the functional elements produced therefrom consists in their use as an electronic component, for example as a molecular circuit in medical technology or in a biocomputer. Particular preference is given to the use of the inventive functionalized carrier or of a functional element produced therefrom as an optical store in optical information processing, in which case the inventive functionalized carrier comprises photoreceptor protein immobilized on nanoparticles, which can convert light directly to a signal.

Using the inventive functionalized carriers or the inventive functional elements produced therefrom, it is also possible to prepare entire substance libraries from available starting materials, i.e. the inventive functionalized carriers or the functional elements produced therefrom can also be used in synthetic chemistry processes also known as combinatorial chemistry. The novel compounds thus prepared with their different but related molecular structures can then be analyzed for their usability as medicaments, catalysts or materials. The compound to be synthesized is synthesized on the inventive functionalized carriers or the functional elements produced therefrom. The substances are built up in a plurality of steps using, for example, the “split and combine” method. When, for example, more than 20 starting substances, for example amino acids, are used in this method, all 8000 possible tripeptides which can form from 20 amino acids can be obtained within only 30 reaction steps. The combinatorial libraries prepared using such methods can then be analyzed with regard to their biological properties, as are of interest, for example, in the field of pharmaceutical research, but also with regard to physical properties such as light emission, etc. Using the inventive functionalized carriers or the functional elements produced therefrom, it is possible to perform virtually all reactions which can be performed in the liquid phase. The attachment or immobilization of a reactant gives rise to the possibility of freely selecting further substances or of adding them in solution. The inventive functionalized carriers or the functional elements produced therefrom are suitable in particular for the synthesis of natural substances, i.e., in particular, for the synthesis of complex compounds.

The present invention likewise relates to the use of the inventive functionalized carrier or of the functional elements produced using such carriers as a catalyst for chemical or enzymatic reactions, wherein the catalyst is immobilized on the nanoparticles.

The invention also envisages the use of the functionalized carrier or of the functional elements produced using the carrier for the removal of compounds from liquids, i.e. use as a flow device. Using the inventive functionalizable carrier, or a functional element produced therefrom, especially a flow device, it is possible, for example, to automate the synthesis of molecular libraries. Also in accordance with the invention is the use of the functionalized carrier or of the functional elements produced using the carrier for the purification of liquids.

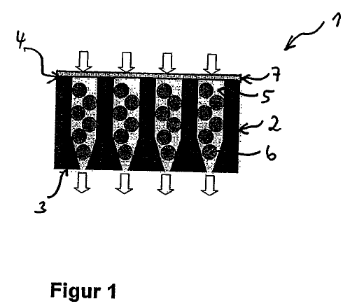

The invention is illustrated in detail by FIG. 1.

FIG. 1 shows, in schematic form, an inventive functionalized carrier. The functionalized carrier (1) comprises a porous material (2) with the surface (3) arranged on the lower side of the material (2) and the surface (4) arranged on the upper side of the material (2), the two opposite surfaces (3) and (4) being planar and having pores (5). The pores (5) are designed as continuous pores, i.e. they extend from the surface (3) through the porous material (2) to the opposite surface (4). Nanoparticles (6) which may have, for example, molecule-specific recognition sites not shown here are in the pores (5). Additionally arranged on the surface (4) is a separating layer (7). The arrows show the feed direction of a solution which is not shown and may comprise, for example, analytes, reagents, etc., into the pores (5) of the functionalized carrier (1), and the removal direction of the solution after it has passed through the pores (5) comprising nanoparticles (6) out of the functionalized carrier (1).

1. A functionalized porous carrier comprising a material having a first surface arranged on an upper side of the material and a second surface arranged on a lower side of the material, at least one said surface being planar and having pores and a plurality of nanoparticles being arranged in each of the pores of at least one region of the porous surface, and the nanoparticles having molecule-specific recognition sites.

2. The functionalized carrier according to claim 1, wherein both said first and said second surfaces of the material are planar and have pores.

3. The functionalized carrier according to claim 2, wherein the pores of said first and said second surfaces are not connected to one another.

4. The functionalized carrier according to claim 2, wherein the pores of said first and said second surfaces are connected to one another by connecting channels.

5. The functionalized carrier according to claim 1, wherein the material having at least one porous surface is a membrane.

6. The functionalized carrier according to claim 5, wherein the membrane is a microporous membrane.

7. The functionalized carrier according to claim 6, wherein the microporous membrane is an inorganic microporous membrane.

8. The functionalized carrier according to claim 7, wherein the inorganic membrane is comprised of at least one of ceramic, glass, silicon, metal, metal oxide and a mixture thereof.

9. The functionalized carrier according to claim 5, wherein the membrane is a microporous polymer membrane.

10. The functionalized carrier according to claim 9, wherein the polymer membrane is comprised of at least one of a polyamide, polyvinylidene fluoride, a polyether sulfone, a polysulfone, a polycarbonate, polypropylene, cellulose acetate, cellulose nitrite, a cellulose with a chemical modified surface and a mixture thereof.

11. The functionalized carrier according to claim 1, wherein the pores have molecule-specific recognition sites.

12. The functionalized carrier according to claim 1, wherein at least one porous surface has a plurality of regions arranged according to a predetermined pattern, in whose pores nanoparticles are present.

13. The functionalized carrier according to claim 12, wherein the regions comprising nanoparticles are delimited by zones which are covered with a nonporous film.

14. The functionalized carrier according to claim 12, wherein the regions comprising nanoparticles are separated from one another either by zones of reduced porosity or by nonporous zones.

15. The functionalized carrier according to claim 12, wherein the regions comprising nanoparticles are separated from one another by zones which are modified with a chemical compound which, to at least one of prevent nonspecific binding and minimize contact of a sample liquid with the zones.

16. The functionalized carrier according to claim 12, wherein the pores of the individual regions contain identical or different nanoparticles.

17. The functionalized carrier according to claim 1, wherein the nanoparticles are fixed in the pores.

18. The functionalized carrier according to claim 17, wherein the nanoparticles are fixed in the pores by a bonding agent.

19. The functionalized carrier according to claim 18, wherein the bonding agent has charged or uncharged chemically reactive groups.

20. The functionalized carrier according to claim 1, wherein the nanoparticles have a core and a surface, said surface having the molecule-specific recognition sites.

21. The functionalized carrier according to claim 20, wherein one or more biologically active molecules are bound to the molecule-specific recognition sites.

22. The functionalized carrier according to claim 21, wherein the biologically active molecules are bonded by a method selected from the group consisting of covalent bonding, noncovalent bonding and a combination thereof.

23. The functionalized carrier according to claim 21, wherein the molecules are bound with retention of their biological activity.

24. The functionalized carrier according to claim 21, wherein the bound molecules are selected from proteins, nucleic acids and fragments thereof.

25. The functionalized carrier according to claim 24, wherein the nucleic acids are selected from the group consisting of single- and double-strand DNA, RNA, PNA and LNA molecules.

26. The functionalized carrier according to claim 24, wherein the proteins are selected from the group consisting of antibodies, antigens, enzymes, cytokines and receptors.

27. The functionalized carrier according to claim 20, wherein the molecule-specific recognition sites comprise at least one first functional group and the bound molecules comprise complementary second functional groups which bind the first functional groups.

28. The functionalized carrier according to claim 27, wherein the first functional groups and the complementary second functional groups which bind the first functional groups are selected from the group consisting of active ester, alkyl ketone group, aldehyde group, amino group, carboxyl group, epoxy group, maleimido group, hydrazine group, hydrazide group, thiol group, thioester group, oligohistidine group, Strep-Tag I, Strep-Tag II, desthiobiotin, biotin, chitin, chitin derivatives, chitin-binding domains, metal chelate complex, streptavidin, streptactin, avidin and neutravidin.

29. The functionalized carrier according to claim 27, wherein the first and the second functional groups are obtained by molecular imprinting.

30. The functionalized carrier according to claim 27, wherein the first functional groups are part of a spacer or are bonded to the surface of the nanoparticles via spacers.

31. The functionalized carrier according to claim 27, wherein the complementary second functional groups are part of a spacer or are bonded to the molecules via spacers.

32. The functionalized support according to claim 20, wherein the core of the nanoparticles comprises an organic material.

33. The functionalized carrier according to claim 32, wherein the organic material is an organic polymer.

34. The functionalized carrier according to claim 33, wherein the organic polymer is selected from the group consisting of polypropylene, polystyrene, polyacrylate and mixtures thereof.

35. The functionalized carrier according to claim 20, wherein the core comprises an inorganic material.

36. The functionalized carrier according to claim 35, wherein the inorganic material is selected from the group consisting of a metal, silicon, SiO2, SiO, a silicate, Al2O3, SiO2.Al2O3, Fe2O3, Ag2O, TiO2, ZrO2, Zr2O3, Ta2O5, zeolite, glass, indium tin oxide, hydroxylapatite, a Q-dot and mixtures thereof.

37. The functionalized carrier according to claim 32, wherein the core has at least one additional function.

38. The functionalized carrier according to claim 37, wherein the additional function is anchored in the core and is selected from the group consisting of a fluorescence label, a UV/VIS label, a superparamagnetic function, a ferromagnetic function, a radioactive label and combinations thereof.

39. The functionalized carrier according to claim 37, wherein the surface of the core is modified with an organic or inorganic layer which comprises the first functional groups and has a label selected from the group consisting of a fluorescence label, a UV/VIS label, a superparamagnetic function, a ferromagnetic function, a radioactive label and combinations thereof.

40. The functionalized carrier according to claim 37, wherein the surface of the core comprises a chemical compound which serves at least one purpose selected from the group consisting of steric stabilization, to prevent a change in conformation of the immobilized molecules and to prevent the addition of a further biologically active compound onto the core.

41. The functionalized carrier according to claim 40, wherein the chemical compound is selected from the group consisting of a hydrogel, a polyethylene glycol, an oligoethylene glycol, dextran and mixtures thereof.

42. The functionalized carrier according to claim 21, wherein the bound molecules have a marker.

43. The functionalized carrier according to claim 21, wherein further molecules are bound to the bound molecules.

44. The functionalized carrier according to claim 1, wherein at least one separating layer is arranged on at least one of the first and second porous surfaces.

45. A functional element comprising at least one functionalized carrier according to claim 1.

46. The functional element according to claim 45, wherein the at least one functionalized carrier is arranged on the surface of a nonporous material.

47. The functional element according to claim 46, wherein the at least one functionalized carrier covers the entire surface of the nonporous material.

48. The functional element according to claim 46, wherein the at least one functionalized carrier covers a plurality of surface sections, arranged according to a predetermined pattern, of the surface of the nonporous material.

49. The functional element according to claim 48, wherein the individual sections of the surface of the nonporous material are covered with different functionalized carriers.

50. The functional element according to claim 49, wherein the different functionalized carriers comprise nanoparticles with at least one of different molecule-specific recognition sequences and different bound biologically active molecules.

51. The functional element according to claim 48, wherein the sections of the surface of the nonporous material which are covered with the functionalized carrier are separated by nonporous zones or zones with reduced porosity.

52. The functional element according to claim 45, wherein the at least one functionalized carrier is arranged in or on a frame composed of a nonporous material or a material with reduced porosity.

53. The functional element according to claim 52, wherein the surface of the functionalized carrier enclosed by the frame is interrupted by supporting elements of a nonporous material or a material with reduced porosity bonded to the frame.

54. The functional element according to claim 46, wherein at least one of the nonporous material and the surface of the nonporous material comprises a material selected from the group consisting of a metal, metal oxide, polymer, semiconductor material, glass, ceramic and mixtures thereof.

55. The functional element according to claim 45, wherein said element is a microtiter plate having at least one depression and wherein the at least one depression is covered fully or partly with a functionalized carrier.

56. The functional element according to claim 45, wherein the element is a microarray device.

57. The functional element according to claim 56, wherein the microarray device is a nucleic acid chip or a protein chip.

58. The functional element according to claim 45, wherein the element is a flow device.

59. The functional element according to claim 58, wherein the flow device is used for at least one of removing, enriching and concentrating a compound from a liquid.

60. The functional element according to claim 58, wherein the flow device is adapted to purify a liquid.

61. The functional element according to claim 45, wherein the element is an electronic component in a biocomputer.

62. A process for producing a functionalized carrier according to claim 1, comprising applying a suspension of nanoparticles having molecule-specific recognition sequences to the porous surface of a material and removing residual suspension after the nanoparticles have penetrated into the pores of the material.

63. The process according to claim 62, wherein the porous material surface is subjected to a treatment to destroy the pore structure in predefined regions of the surface before the nanoparticle suspension is applied.

64. The process according to claim 63, wherein the porous material surface is treated by a laser.

65. The process according to claim 62, wherein nanoparticles which have not penetrated into the pores and the remaining constituents of the suspension are removed by flushing with a liquid medium.

66. A method for producing a functional element according to claim 45 which comprises forming said functional element with a functionalized carrier.

67. A method for performing a detection process, said method comprising using a functionalized carrier according to claim 1 to carry out said detection.

68. The method according to claim 67, wherein the detection process is selected from the group consisting of MALDI mass spectroscopy, fluorescence spectroscopy, UV-VIS spectroscopy, fluorescence microscopy, light microscopy, waveguide spectroscopy, impedance spectroscopy, another electrical process and an enzymatic process.

69. A method for developing pharmaceutical preparations, said method comprising using a functionalized carrier according to claim 1 to carry out said development.

70. A method for analyzing at least one of the effects and the side effects of a pharmaceutical preparation, said method comprising using a functionalized carrier according to claim 1 to carry out said analysis.

71. A method for diagnosing disorders, said method comprising using a functionalized carrier according to claim 1 to carry out said diagnosis.

72. The method according to claim 71, wherein the functionalized carrier is used to identify pathogens.

73. The method according to claim 71, wherein the functionalized carrier is used to identify mutated genes in a human or an animal.

74. The method according to claim 71, wherein the functionalized carrier is used to identify diagnostically relevant metabolites.

75. A method for online or offline monitoring of fermentation processes, said method comprising using a functionalized carrier according to claim 1 to carry out said monitoring.

76. A method for analyzing microbiological contamination of samples, said method comprising using a functionalized carrier according to claim 1 to carry out said analysis.

77. The method according to claim 76, wherein the sample is a water or a soil sample.

78. The method according to claim 76, wherein the sample stems from a food or animal feed.

79. A method for catalyzing a chemical reaction, wherein said method comprises using a functionalized carrier according to claim 1 to serve the catalytic function.

80. A method for synthesizing an organic compound, said method comprising using a functinalized carrier according to claim 1 for said synthesis.

81. The method according to claim 80, wherein the organic compounds are selected from the group consisting of nucleic acids, proteins and polymers.

82. A method for forming a biocomputer, which method comprises including in said biocomputer a functionalized carrier according to claim 1.

83. A method for at least one of removing compounds from liquids and for purifying liquids, said method comprising using a functionalized carrier according to claim 1 for said at least one of removal and purification.

84. A method for performing a detection process, said method comprising using a functional element according to claim 45 to carry out said detection.

85. The method according to claim 84, wherein the detection process is selected from the group consisting of MALDI mass spectroscopy, fluorescence spectroscopy, UV-VIS spectroscopy, fluorescence microscopy, light microscopy, waveguide spectroscopy, impedance spectroscopy, another electrical process and an enzymatic process.

86. The method according to claim 67, wherein the detection process is an enzymatic process and wherein said process uses an enzyme selected from the group consisting of a peroxidase, a galactosidase and an alkaline phosphatase.

87. The method according to claim 85, wherein the detection process is an enzymatic process and wherein said process uses are enzyme selected from the group consisting of a peroxidase, a galactosidase and an alkaline phosphatase.

88. A method for developing pharmaceutical preparations, said method comprising using a functional element according to claim 45 to carry out said development.

89. A method for analyzing at least one of the effects and the side effects of a pharmaceutical preparation, said method comprising using a functional element according to claim 45 to carry out said analysis.

90. A method for diagnosing disorders, said method comprising using a functional element according to claim 45 to carry out said diagnosis.

91. The method according to claim 71, wherein the functional element is used to identify pathogens.

92. The method according to claim 71, wherein the functional element is used to identify mutated genes in a human or an animal.

93. The method according to claim 71, wherein the functional element is used to identify diagnostically relevant metabolites.

94. A method for online or offline monitoring of fermentation processes, said method comprising using a functional element according to claim 45 to carry out said monitoring.

95. A method for analyzing microbiological contamination of samples, said method comprising using a functional element according to claim 45 to carry out said analysis.

96. The method according to claim 95, wherein the sample is a water or a soil sample.

97. The method according to claim 95, wherein the sample stems from food or animal feed.

98. A method for catalyzing a chemical reaction, wherein said method comprises using a functional element according to claim 45 to serve the catalytic function.

99. A method for synthesizing organic compounds, said method comprising using a functional element according to claim 45 for said synthesis.

100. The method according to claim 99, wherein the organic compounds are selected from the group consisting of nucleic acids, proteins and polymers.

101. A method for forming a biocomputer, which method comprises incorporating within said biocomputer a functional element according to claim 61.

102. A method for at least one of removing compounds from liquids and for purifying liquids, wherein said method comprises using a functional element according to claim 58 for said at least one of removal and said purification
